(19) United States
(12) Patent Application Publication
(10) Pub. No.: US 2017/0014992 A1
(43) Pub. Date: Jan. 19, 2017

(54) DEVICE WITH A MANIPULATOR UNIT

(71) Applicant: WAELISCHMILLER ENGINEERING GMBH, Markdorf (DE)

(72) Inventor: Kenji HARA, Meersburg (DE)

(73) Assignee: WAELISCHMILLER ENGINEERING GMBH, Markdorf (DE)

(21) Appl. No.: 15/220,545

(22) Filed: Jul. 27, 2016

Related U.S. Application Data
(63) Continuation of application No. PCT/EP2015/051904, filed on Jan. 30, 2015.

(30) Foreign Application Priority Data
Jan. 30, 2014 (DE) 10 2014 001 074.0

(51) Int. Cl. B25J 5/00; G21C 17/013

(52) U.S. Cl. CPC B25J 5/00; G21C 17/013

(57) ABSTRACT

A device with a manipulator unit which comprises a driveable manipulator arm is proposed. According to the present invention, there is a lifting arrangement with a flexible pulling element, on which lifting arrangement the manipulator unit is lowerable and/or raisable in a suspended manner, wherein coupling means acting between the flexible pulling element and the manipulator unit are present designed in such a manner that the manipulator unit in the suspended state on the pulling element is adjustable spatially about an axis in order to set a predefined orientation.

### CROSS REFERENCE TO RELATED APPLICATIONS

This application is a continuation of International Application No. PCT/EP2015/051904 filed Jan. 30, 2015, which designated the United States, and claims the benefit under 35 USC §119(a)-(d) of German Application No. 10 2014 001 074.0 filed Jan. 30, 2014, the entireties of which are incorporated herein by reference.

### FIELD OF THE INVENTION

The present invention relates to a device with a manipulator unit.

### BACKGROUND OF THE INVENTION

Devices with a manipulator unit or manipulator systems are used for a multiplicity of different tasks. As a rule, these involve remote-controlled actions which cannot be undertaken by individuals directly in situ, in particular, because of risks to the individuals during the work or because of the inaccessibility of the use location to the operator and/or because of other risks prevailing locally there. Such scenarios occur, for example, as a consequence of catastrophes, in regions with a non-tolerable potential of danger to human life due to risk-affected or alien ambient conditions in the event of extreme mechanical, chemical or physical potentials of hazard, for example, due to caving-in risks, poisonous substances, extreme temperatures or pressures and/or critical radioactive radiation values.

### SUMMARY OF THE INVENTION

It is an object of the present invention advantageously to provide a device which is mentioned in the introduction and which is, in particular, of compact design and can be used in a variable manner for a multiplicity of comparatively complex tasks.

The present invention is based on a device with a manipulator unit which comprises a driveable manipulator arm. The manipulator arm is moveable in a complex manner, for example, by remote control, and is individually equipable for different work. Different functionalities can be realized at the manipulator arm, for example, by means of tools which are present interchangeably thereon and operate in a driven manner.

The essence of the present invention consists in that there is a lifting arrangement with a flexible pulling element, on which lifting arrangement the manipulator unit is lowerable and/or raisable in a suspended manner, wherein coupling means acting between the flexible pulling element and a basic body of the manipulator unit are present in such a manner that, in the suspended state of the manipulator unit on the pulling element, the basic body is adjustable in order to set a predefined spatial orientation of the basic body. In the suspended state of the manipulator unit on the pulling element, the basic body is adjustable, in particular, linearly and/or so as to pivot about an axis. A device which is overall comparatively compact and is useable in a variable manner and has a manipulator unit is therefore provided, the device having a comparatively low weight.

With the device according to the present invention, even under extremely difficult conditions, work can be carried out by the controllably operating manipulator unit from a safe distance from the region of use of the manipulator unit. The use of the device is advantageous, in particular, for example, in the case of spatially difficult access to the use region, in the event of confined conditions or in the event of conditions affected by high risk.

This is advantageous, for example, for aid in a catastrophe.

In addition to the lifting arrangement, the device comprises the manipulator unit, which includes an, in particular, wired energy and/or signal supply and the coupling means. The manipulator arm and further elements of the manipulator unit are explained in more detail further below. For the visual detection of the area around the manipulator unit and for forwarding corresponding image information, the manipulator unit has an image-providing system or a camera.

The lifting arrangement which serves for moving the manipulator unit in the vertical direction and is constructed simply and with a low weight allows the manipulator unit to move or be raised and lowered vertically and additionally to move transversely with respect thereto to a certain extent.

The transverse movement of the manipulator unit can advantageously be realized both in the tensioned and in the non-tensioned state of the pulling element. In the tensioned state of the pulling element, the manipulator unit can be fixed, lowered or raised vertically at any time simultaneously to the transverse movement, which advantageously permits a precise and situation-adapted manner of operation of the manipulator unit.

The lifting arrangement comprises at least one pulling element, but may also comprise, for example, a plurality of separate, flexible pulling elements, depending on the forces to be absorbed. The plurality of pulling elements are advantageously constructed in a similar manner and are oriented parallel to one another, which requires less space horizontally and simplifies the lifting arrangement and the operation thereof.

Examples of suitable pulling elements include a steel or fabric material in cylinder or cable form, a chain or a high-strength flexible band.

In addition, the lifting arrangement advantageously has an arrangement for the motorized shortening and lengthening of a freely suspended pulling element portion in order to change the vertical position of the manipulator unit depending on the length of the pulling element hanging in a vertically stretched manner. For example, the lifting arrangement has a winding device for the pulling element, such as a cable drum or the like. Furthermore, it is advantageous if the lifting arrangement itself is changeable in its spatial position, for example is moveable linearly or horizontally.

The pulling element can optionally be designed with the additional function for the energy and/or signal supply of the manipulator unit from the outside. However, as a rule, the energy and/or signal supply of the manipulator unit is set up via at least one elongate, flexible element which is separate from the pulling element, such as an energy and signal cable. The energy and signal cable can likewise be pulled upward or let out downward by the lifting arrangement depending on the vertical position of the manipulator unit. With the comparatively compact and slender devices according to the present invention that are configured in a material-saving manner, locations can also be reached that have only access from above which is difficult, for example, is constricted and/or is partially displaced by obstacles, and which lie, for example, 20 meters, 30 meters, 40 meters or lower than the access, which can be reached from the outside, above the use region.

In the suspended state of the manipulator unit, in particular, if the manipulator unit is held in a freely suspended manner solely via the pulling element, the basic body of the manipulator unit is adjustable in its spatial orientation. The manipulator unit can be free from contact in the surrounding gas or liquid medium from surrounding solid bodies, such as walls or a base section. The basic body of the manipulator unit can be adjusted from a first predefined spatial orientation into a predetermined second spatial orientation and also can be adjusted back again. The coupling means can optionally be configured in such a manner that further predeterminable spatial orientations of the basic body can be set. A situation- or environment-adapted operation of the manipulator unit can thus be realized. The basic body can optionally be pivoted or tilted about an axis, for example, by a maximum of up to 360 degrees of angle or, in particular, by a maximum of approx. 90 degrees of angle. The adjustment means can permit adjustment of the basic body about a first axis and additionally about a second axis oriented transversely with respect to the first axis.

A manipulator unit section associated with the coupling means is advantageously provided, which section is present between the pulling element and the basic body and which is not adjusted during the adjustment of the basic body itself, for example, a rigid coupling element of the coupling means.

The coupling means are, in particular, designed in such a manner that the adjustment is possible in the state of the pulling element which is tensioned taut under the mass of the manipulator unit hanging thereon and subjected to a tensile load. This is advantageous since the adjustment of the basic body has to be possible from a remote location from the outside frequently without any support of the manipulator unit, for example, on a wall or a base section in the immediate vicinity of the manipulator unit.

A main plane of the manipulator unit is advantageously adjustable, in particular, tiltable by a tilting movement, from a vertical orientation into a horizontal orientation. The coupling means are configured in such a manner that the tilting takes place, in particular, from an at least approximately vertical orientation of the main plane into an at least approximately horizontal orientation. The tilting can take place in precisely one tilting direction or in both possible tilting directions about the tilting axis. The main plane is, in particular, a flat side of the basic body of the manipulator unit, for example, an upper or lower side of the basic body. The main plane can be formed, for example, by part of an outer side of a housing of the basic body. The main plane can be flat or can be a side of the basic body of the manipulator unit, which side is provided with elevations and/or depressions.

The basic body of the manipulator unit can have, in particular, a box-like or a plate-like or cuboidal basic shape, with a, for example, square or polygonal area, in particular, with a corresponding housing shape. In addition to the manipulator arm, as a rule further essential elements of the manipulator unit, such as, for example, motors, gearings, couplings, lines and the like are arranged in and/or on the housing of the basic body.

The basic body can advantageously be adjusted in such a manner that the manipulator unit has a compact outer form, for example, in the case of a vertically oriented main plane of the basic body, and therefore a maximum outer extent of the manipulator unit in the horizontal direction with the manipulator unit freely suspended can be, for example, below one meter. The device according to the present invention can thus advantageously be used for applications in which access to the use location from above has a free opening extent of below one meter. The manipulator unit can be let down through openings which have an elongate narrow shape, for example, a gap shape, since the manipulator unit has an elongate narrow shape in the case of a vertically oriented main plane of the basic body itself.

An advantageous refinement of the device according to the present invention in a configuration for virtually any critical uses has, with respect to a compact state with the manipulator arm folded in and optionally with further moveable members folded in on the basic body, for example, the following typical dimension regions of the manipulator unit: for example, at maximum approx. 2000 to 3000 millimeters vertically or in height including the coupling means, for example, at maximum approx. 600 to 1000 millimeters in a first horizontal width and, for example, at maximum approx. 1800 to 2200 millimeters in a second horizontal width, as measured transversely with respect to the first horizontal width.

It is furthermore proposed that the coupling means comprise an at least substantially rigid coupling element connected to the pulling element. The rigid coupling element is connected to the pulling element by itself or with the interconnection of a, for example, encapsulated intermediate section. The coupling element is, in particular, of elongate and slender design. Components may be accommodated in the interior of the coupling element, or a feedthrough of a signal and energy supply up to or into the basic body may be present.

The coupling element is positioned, in particular, between the pulling element and the basic body. The intermediate section can adjoin the coupling element, for example, above the latter.

Furthermore, it is advantageous that the coupling means act on the manipulator unit via an adjustment arrangement. In particular, the adjustment arrangement comprises an articulated or tilting arrangement. The adjustment with the adjustment arrangement preferably takes place about a substantially horizontal axis with respect to the manipulator unit hanging freely on the pulling element. The adjustment arrangement can be designed such that an adjustment takes place assisted by gravity, for example, on the basis of a consciously implemented shifting of the center of gravity of the basic body of the manipulator unit. As a rule, a motorized drive is necessary for shifting the center of gravity of the basic body, for example, by unfolding or folding away an element acting in an articulated manner on the outside of the basic body, such as, for example, of the manipulator arm or of a contact member.

An advantageous modification of the subject matter of the present invention is distinguished in that the adjustment arrangement is present in the region of a center of gravity of the manipulator unit, in particular, in the region of a center of gravity of the basic body of the manipulator unit. For example, a tilting axis or axis of articulation of an adjustment arrangement configured as an articulation arrangement passes through a region around the center of gravity of the manipulator unit or of the basic body or passes directly through the center of gravity. A comparatively small shifting of the center of gravity of the basic body from a stable or balanced position can advantageously lead to a tilting moment acting on the basic body, with respect to the tilting axis of the articulation arrangement.

Furthermore, according to an advantageous refinement of the present invention, it is proposed that a plurality of contact members which are moveable in a driven manner are present on the manipulator unit. The contact members are present, for example, protruding on the outside of the basic body, for example, in a symmetrically distributed manner. In particular, the contact members protrude on narrow sides of the substantially plate-liked basic body. Each contact member which has, for example, a plurality of contact member sections which are connected via joints is in each case separately driveable and therefore spatially moveable. The movement is controllable via the control unit of the manipulator unit. A contact member has, in particular, a plurality of sections connected in an articulated manner, wherein the contact member is moved relative to the basic body of the manipulator unit, in particular, with reference to three movement axes. Each movement of the sections takes place in a motorized manner via one or more corresponding driving motors of the manipulator unit. The plurality of contact members are preferably configured in a similar manner. With the contact members, the manipulator unit can be supported or positioned standing securely or at a standstill on a mating section, such as, for example, a vertical wall or a lateral or contoured floor. In addition, the plurality of contact members are movable by means of the control unit in such a manner that the manipulator unit can move on the mating section in a secure and controlled manner in any direction along the mating section.

It is also advantageous that a contact member is designed with a functionality. Functionality should be understood as meaning, for example, a mechanism going beyond a support or leaning of the contact member on a base section, which is virtually always possible because of gravity. In particular, a functionality can be present consciously on the contact member, in particular, at the front end of the contact member.

A plurality of functionalities are preferably provided on a section of the contact member, for example, at a free end of the contact member. Of the plurality of functionalities, for example, in each case precisely one is selectable and useable, as long as the other functionalities are not active, but may be selected at any time according to the situation.

In an advantageous manner, on a contact member there are adhesive means for setting up a holding function between the contact member and a mating section. The adhesive means can serve, in particular, for the releasable adhesion to a mating section. The adhesive means, which can also be understood as one functionality, and also other functionalities, can be switched on and off or set actively and passively in an advantageously defined manner, for example, by an individual from a remote operating location via, for example, operating means. Alternatively, this can take place in an automated manner. For example, the adhesive means comprise a suction arrangement or negative pressure arrangement for fixing the contact member on the mating section or for moving the manipulator unit along the mating section, such as a wall or floor. The manipulator unit can therefore optionally even be held on overhanging wall sections and/or can move therealong.

Furthermore, advantageously with the adhesive means, an object can be gripped, moved and/or held in a positionally fixed manner relative to the manipulator unit with one or more contact members. The manipulator arm is advantageously configured in such a manner that an object held by at least one contact member can advantageously be processed or investigated by the manipulator arm, for example, a sample of the material of the object can be taken.

It is also advantageous if sensor means for the sensory detection of the surroundings of the manipulator unit are provided. A very wide variety of data can therefore be detected from the environment of the manipulator unit in order to permit conclusions regarding the composition of the environment, in particular, online and therefore immediately or close in time.

The sensor means should be understood without restriction and can comprise different or all known means for detecting and processing parameters in the environment of the manipulator unit. This includes, in particular, sensors for the qualitative and/or quantitative detection of radioactive radiation, the temperature, the pressure, the pH value and other physical or chemical variables in a gaseous or liquid surrounding medium or of objects in the environment of the manipulator unit.

According to a preferred modification, in addition to the lifting arrangement, additional driving means for driven movements of the manipulator unit in the medium surrounding the manipulator unit are provided. The additional driving means are present in addition to the driven contact members which likewise permit a driven movement. In particular, the manipulator unit which hangs on the pulling element in the manner of a pendulum or freely can be moved with the additional driving means in a direction transversely with respect to the vertical. The vertical movement of the manipulator unit downward and upward takes place, in particular, with the lifting arrangement, in particular, via the pulling element which is lengthened and shortened.

With the additional driving means, the manipulator unit can be moved, for example, sufficiently close to a wall such that the manipulator unit can act on the wall, in particular, such that the adhesive means can enter into operative contact with the wall, and the manipulator unit is positionable fixedly thereon or can move therealong. The driving means are, in particular, of importance if the wall is spaced apart horizontally or laterally from an access, which is located thereabove and via which the manipulator unit hanging on the pulling element is lowerable vertically, further than can be spanned with the manipulator arm or a contact member. This is also advantageous if a region of an inner wall of hollow-cylindrical, hollow-spherical or similarly shaped hollow spaces has to be reached by the manipulator unit, but this region is accessible from above only via the access which is offset horizontally with respect to the inner wall and through which the manipulator unit hanging on the pulling element is let down vertically.

The driving means can comprise, for example, on the basic body, one or more driveable or rotating propellers with a propeller rotation axis which is oblique or is directed transversely with respect to the vertical or to the longitudinal axis of the tensioned pulling element.

Furthermore, it is advantageous that radiation protection means are provided which reduce or avoid penetration of radiation from the outside into an internal volume of the manipulator unit. The radiation protection means serve to protect part of the internal volume of the device against radiation, in particular, to protect same against radioactive radiation, in order to protect radiation-sensitive appliances, for example, electronic means which are accommodated in the manipulator unit, against the effect of the radioactive radiation.

In particular, the radiation protection means comprise a sufficiently thick layer made of lead, wherein the lead highly effectively absorbs X-ray and gamma radiation. In particular, the radiation protection means comprise a housing composed of or containing a lead material. The lead housing forms a configuration, which is encapsulated against radiation, of at least regions of the device.

The radiation-protected region can lie, for example, outside the basic body, for example, between the pulling element and the basic body, for example, in the region of the coupling means.

Finally, it is also advantageous that means are designed for operating the device underwater and/or at comparatively high temperatures. The means relate, in particular, to liquid-tight housing materials or sealing arrangements for the liquid-tight design, for example, in connecting regions of housing parts to be connected to one another or at connecting points in the transition from components acting on the housing, such as the manipulator arm. Highly heat-resistant materials are used against heat, the materials being resistant at typical maximum temperatures which can occur in catastrophe scenarios.

The device is therefore advantageously configured for any conceivable uses in a catastrophe.

In addition, suitable measures are taken for the mechanical stability of the device, in particular, against the effect of impact or pressure. For example, a housing can be provided with a suitable high-strength outer skin made of a steel material.

### BRIEF DESCRIPTION OF THE DRAWINGS

Further features and advantages of the present invention are explained in more detail with reference to a schematized exemplary embodiment of the present invention.

FIG. 1 shows, in a schematized perspective view, an exemplary embodiment of a device according to the present invention in a working environment;

FIGS. 2 to 4 show different views of part of the device according to FIG. 1 in a state preferred for letting the device down or raising the device;

FIGS. 5 to 7 show various views of part of the device in a first spatial orientation shown according to FIG. 1; and

FIGS. 8 to 10 shows various views of part of the device shown in FIGS. 1 to 7 in a second spatial orientation suitable for working use.

### DETAILED DESCRIPTION OF THE INVENTION

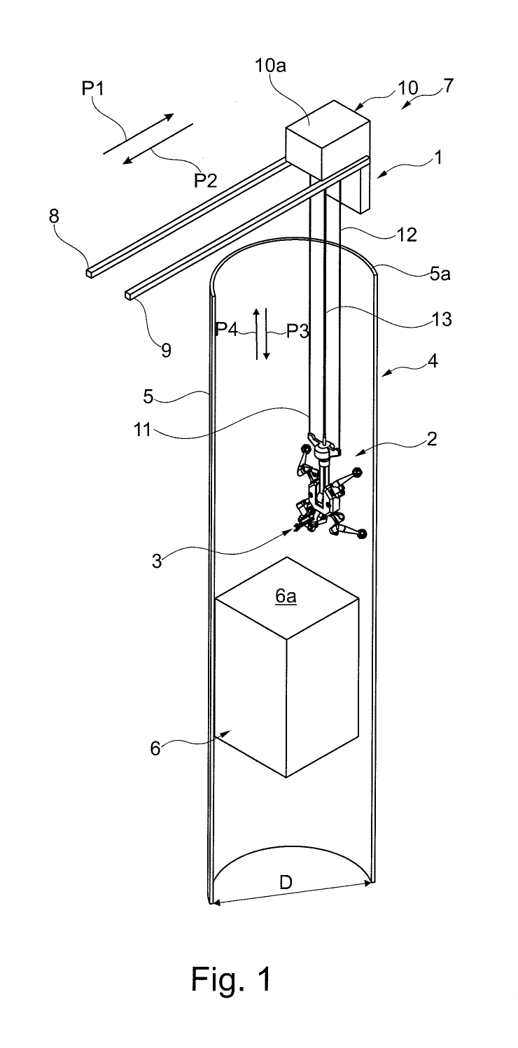

FIG. 1 shows perspectively obliquely from above a device according to the present invention which is designed as a working device 1 and has a lifting arrangement 7 and a manipulator unit 2 which comprises an intermediate piece 19 and a basic body 18 with a driveable manipulator arm 3.

In addition, four similar manipulator legs 14, 15, 16 and 17 which are each moveable separately in a motorized manner are present protruding outward and adjustable on narrow sides of the basic body 18, which is octagonal in area. The manipulator legs 14 and 16 are positioned lying opposite on the basic body 18, as are the manipulator legs 15 and 17.

The manipulator leg 15 is explained in more detail by way of example for all of the manipulator legs 14, 15, 16 and 17. The manipulator leg 15 has three members with a base section 15a acting in an articulated manner on the basic body 18, a central section 15b acting in an articulated manner on the base section 15a, and an end section 15c acting in an articulated manner on the central section 15b. Each member 15a, 15b and 15c is rotatable in a separately driveable manner. The base section 15a is rotatable with respect to the rotation axis S1 in both directions relative to the basic body 18 as per P5, the central section 15b is rotatable with respect to the rotation axis S2 in both directions relative to the base section 15a as per P6, and the end section 15c is rotatable with respect to the rotation axis S3 in both directions relative to the central section 15b as per P7. The rotation axes S2 and S3 are parallel to each other and are perpendicular to the rotation axis S1. The base section 15a and the central section 15b are shaped substantially rectilinearly, whereas the end section 15c has two subsections oriented approximately at right angles to each other. A suction element or adhesive member 28 is arranged at the free front end of the end section 15c. The adhesive member 28 serves as adhesive means for sticking the manipulator leg 15 to a mating section, such as, for example, a wall or base surface which is flat or contoured and is oriented virtually as desired. By means of co-ordinated displacement of the manipulator legs 14, 15, 16 and 17, the manipulator unit 2 can thus be moved forward or in any direction on or along a wall or base surface.

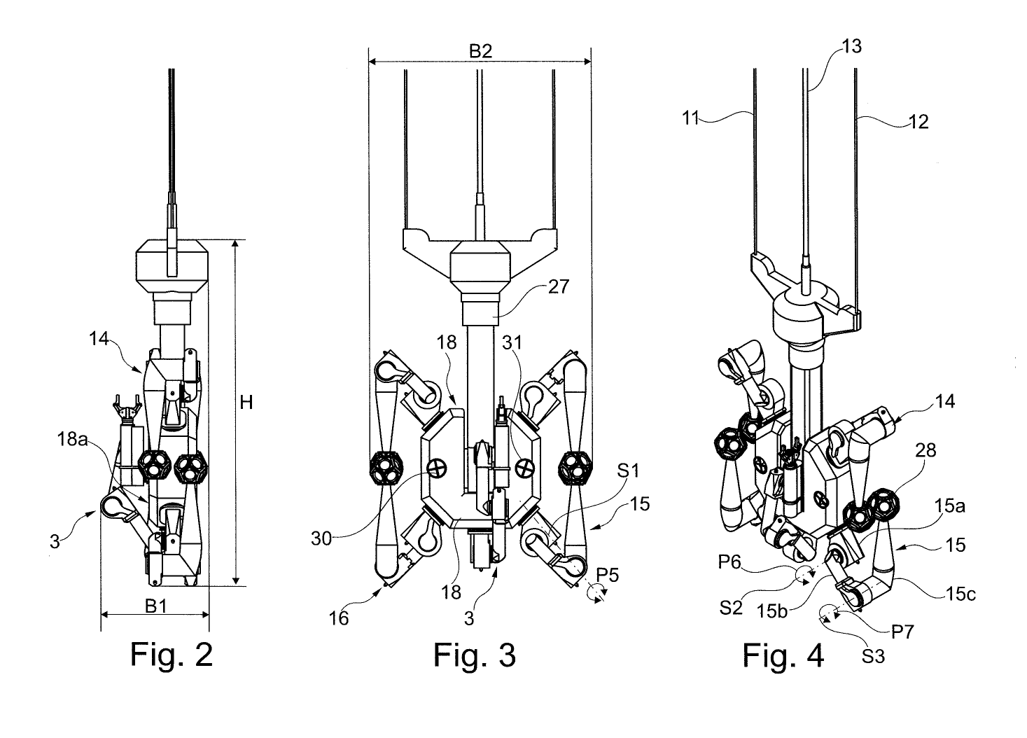

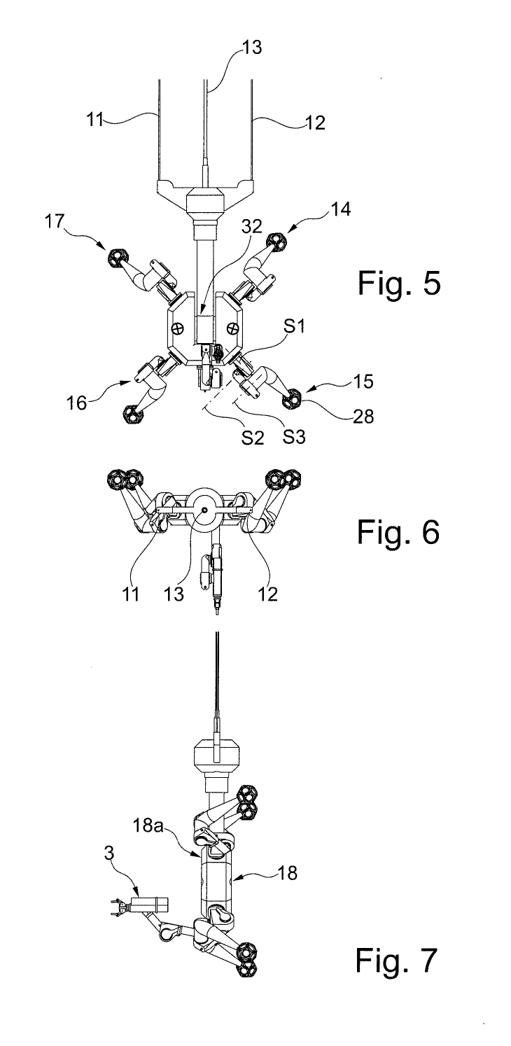

In addition, the manipulator legs 14 to 17 can be adjusted from a transport position according to FIGS. 2 to 4 into a working position according to FIGS. 5 to 7 via a corresponding driven movement of the members about the axes S1 to S3. In the transport position of the manipulator unit 2, the manipulator legs 14 to 17 are folded compactly or tightly against the basic body, wherein the external size of the manipulator unit 2 as a whole is minimized, and it has a first width B1 of, for example, approx. 800 millimeters, a second width B2 of, for example, approx. 2000 millimeters and a height of, for example, approx. 2500 millimeters (see FIGS. 2 and 3), which is advantageous, in particular, for lowering and raising in a confined environment.

The manipulator arm 3 likewise present on a narrow side of the basic body 18 between the manipulator legs 15 and 16 is constructed similarly to the manipulator leg 15 and has an arm base 3a, an arm central part 3b and a tool part 3c with grippers 29 which are moveable in a motorized manner at the front thereof. It is optionally possible for a desired tool functionality to be set up, or a corresponding tool part to be exchangeably attached, on/to the manipulator arm 3, and therefore the respective tool is driveable by the manipulator unit 2 and can execute working operations in the near environment of the manipulator unit 2.

The working device 1 can be operated, for example, by an operator via operating means, in particular, remotely or from a location in a safe environment (not illustrated) which is appropriately sufficiently removed from the region shown in FIG. 1 and/or is safely separated therefrom by, for example, a partition. The operating means may comprise an operating keyboard, an operating panel, a touch screen, a master-slave system and/or a joystick or other operating elements. With the operating means, the working device 1 or the lifting arrangement 7 and the manipulator unit 2 with the manipulator arm 3 and the manipulator legs 14 to 17 can be, in particular, moved, positioned or oriented and operated.

According to FIG. 1, the working device 1 is in working use with the manipulator unit 2 in a working position in the interior of a container 4. The container 4 has a vertically oriented longitudinal axis with a cylindrical casing tube 5 which is only partially shown and is illustrated in the longitudinal direction and sectioned centrally. The container 4 is shown without a base and without a section which covers or overlaps the interior of the container, for example, without a container covering which is connected in the region of an upper edge 5a of the casing tube 5. The container covering can, in particular, have an opening which is smaller in diameter in comparison to a diameter D of the of the casing tube 5 and through which the manipulator unit 2 is lowerable passing rectilinearly downward from above the container covering over a substantial depth in the direction P3. FIG. 1 shows the manipulator unit 2 in a first spatial orientation of a basic body 18 of the manipulator unit 2.

An installed region in the interior of the container 4 is shown in highly abstracted form as a physical cuboid 6 with an upper side 6a.

The lifting arrangement 7 is designed as a rope pull arrangement and comprises a running carriage 10 with a housing 10a having rope and cable drums (not apparent) which are accommodated therein, are rotatable in a motorized manner and are intended for winding up and unwinding two pulling ropes 11 and 12 which each act on a rope drum, and a supply cable 13, which is present therebetween, for the energy and signal supply of the manipulator unit 2. The supply cable 13 is wound up and unwound simultaneously in accordance with the pull ropes 11, 12 via a cable drum in the housing 10a.

The running carriage 10 is driven displaceably in the horizontal direction according to arrows P1 and P2 via two running rails 8 and 9 which run horizontally in parallel and are shown cut off. An energy and control signal feed coming from the outside to the lifting arrangement 7 for the drives of the running carriage 10, of the rope and cable drums or for the energy and signal supply for transmission via the supply cable 13 is not illustrated or can optionally take place via the running rails 8 and 9.

With the rope and cable drums, the two pulling ropes 11, 12 and the supply cable 13 are lowered in direction P3 or raised in direction P4 depending on the direction of rotation of the drums.

FIGS. 2 to 4 show the manipulator unit 2 suspended on the tensioned pulling ropes 11, 12 in the transport position that is advantageous for lowing and raising according to the arrows P3 and P4. FIGS. 2 and 3 show side views rotated with respect to each other by 90 degrees of angle and FIG. 4 shows a perspective view obliquely from above. A flat main side or main plane 18a of the basic body 18 is oriented vertically here (see FIG. 2), parallel to the tensioned pulling ropes 11 and 12.

With an unchanged vertical orientation of the main plane 18a of the basic body 18, FIGS. 5 to 7 show the working device 1 in the working position according to FIG. 1, in particular, for working on a wall surface which is perpendicular or is inclined somewhat with respect thereto, such as, for example, on an inner wall of the casing tube 5. In this working position, the manipulator arm 3 is pivoted away from the basic body 18 relative to the transport position and the manipulator legs 14 to 17 are identically unfolded, wherein FIGS. 5 and 7 show two side views rotated about the vertical by 90 degrees of angle, and FIG. 6 relates to a perspective view from above.

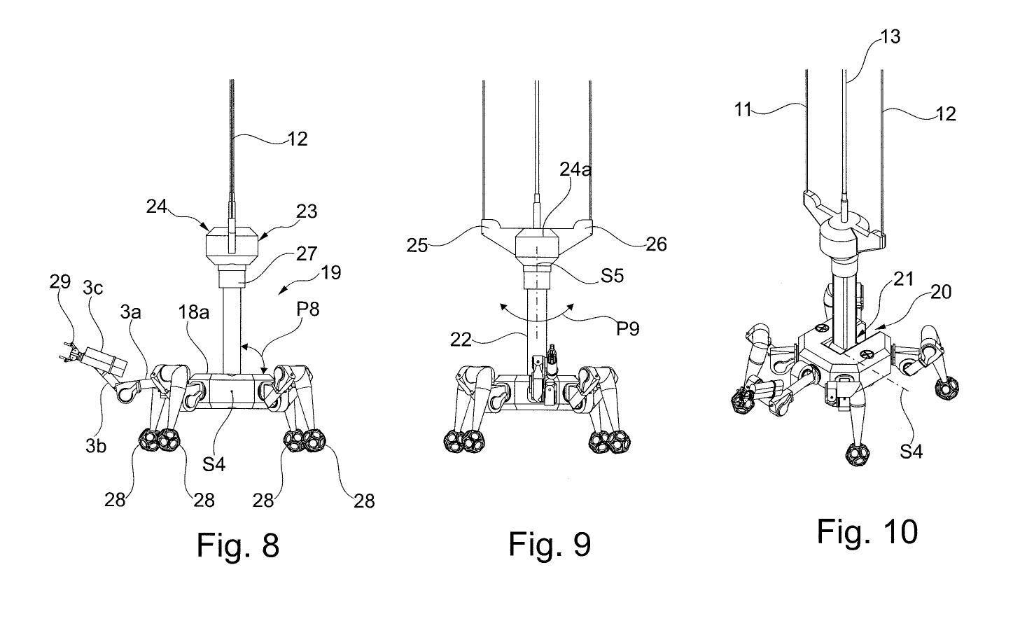

FIGS. 8 to 10 finally show the working device 1 in a further working position in an orientation of the basic body 18 for working, for example, on a base surface which is horizontal or is inclined slightly somewhat with respect to the horizontal, such as the upper side 6a of the cuboid 6. FIG. 8 relates to a first side view, FIG. 9 to a view rotated by 90° about the vertical with respect thereto, and FIG. 10 shows a perspective view obliquely from above.

According to FIGS. 8 to 10, the basic body 18 or the upper-side main plane 18a thereof is oriented tilted or rotated by 90° about a horizontal axis in relation to the arrangement according to FIGS. 5 to 7. The adhesive members 28 of the manipulator legs 14 to 17 rest here with the respective lowermost point thereof on a common plane, for example, for supporting or placing the working device 1 on the upper side 6a.

There are coupling means with the intermediate piece 19 between the supply cable 13 or the pulling ropes 11 and 12 and the basic body 18 of the manipulator unit 2. The coupling means have an elongate rod element 22 which acts on the basic body 18 and is square-shaped here, by way of example, and a receptacle 23 with a capsule 24 and webs 25 and 26 protruding opposite each other thereon. A plug-in section 27 for engagement of the upper end of the rod element 22 is provided on the capsule 24.

An adjustment arrangement 20 having a joint 21 acts between the rod element 22 and the basic body 18 in order to adjust the spatial orientation of the basic body 18 or the main plane 18a thereof relative to the rod element 22 in accordance with the double arrow P8 about an, in particular, horizontal axis S4 (see FIG. 8) which runs in the region of the center of gravity of the basic body 18. The rod element 22 together with the basic body 18 acting thereon are adjustable about a vertical axis S5 by approx. 360 degrees of angle in accordance with the double arrow P9 (see FIG. 9), which is undertaken, in particular, in a motorized manner controlled by the control unit.

In the vertical orientation of the main plane 18a shown in FIGS. 1 to 7, the rod element 22 is arranged in a space-saving manner on the manipulator unit 2. Accordingly, a rectangular recess 32 which is Co-ordinated to the shape of the rod element 22 is present on the basic body 18, advantageously opposite the manipulator arm 3, and therefore a lower part of the rod element 22 can be accommodated aligned within an enveloping surface of the basic body 18 in the non-tilted spatial orientation of the basic body 18 relative to the rod element 22.

In addition, the supply cable 13 acts on the capsule 24. In addition to other elements, the capsule 24 accommodates electronic components which are protected against radiation from the outside by a radiation protective housing, in particular, by a housing 24a or with a housing layer made from lead or with a lead casing.

The rod element 22 is, in particular, hollow and can comprise further elements of the manipulator unit 2. The joint 21 acts between the lower end of the rod element 22 and the basic body 18 of the manipulator unit 2.

For a driven movement in the medium surrounding the manipulator unit 2, such as air or water, there are two rotatable propellers 30, 31 driven in a motorized manner in the basic body 18.

### LIST OF REFERENCE NUMBERS

1 Working device
2 Manipulator unit
3 Manipulator arm
3a Arm base
3b Arm central part
3c Tool part
4 Container
5 Casing tube
5a Edge
6 Cuboid
6a Upper side
7 Lifting arrangement
8, 9 Running rail
10 Running carriage
10a Housing
11, 12 Pulling rope
13 Supply cable
14-17 Manipulator leg
15a Base section
15b Central section
15c End section
18 Basic body
18a Main plane
19 Intermediate piece
20 Adjustment arrangement
21 Joint
22 Rod element
23 Receptacle
24 Capsule
24a Housing
25, 26 Web
27 Plug-in section
28 Adhesive member
29 Grippers
30, 31 Propeller
32 Recess

1. A device with a manipulator unit having a driveable manipulator arm, said device comprising a lifting arrangement with a flexible pulling element, on which lifting arrangement the manipulator unit is lowerable and/or raisable in a suspended manner, and coupling means acting between the flexible pulling element and a basic body of the manipulator unit such that, in the suspended state of the manipulator unit on the pulling element, the basic body is adjustable in order to set a predefined spatial orientation of the basic body.

2. The device as claimed in claim 1, wherein a main plane of the manipulator unit is adjustable from a vertical orientation into a horizontal orientation.

3. The device as claimed in claim 1, wherein the coupling means comprises a substantially rigid coupling element connected to the pulling element.

4. The device as claimed in claim 1, wherein the coupling means acts on the manipulator unit via an adjustment arrangement.

5. The device as claimed in claim 4, wherein the adjustment arrangement is present in the region of a center of gravity of the manipulator unit.

6. The device as claimed in claim 1, wherein the manipulator unit comprises a plurality of contact members that are moveable in a driven manner.

7. The device as claimed in claim 6, wherein at least one contact member is designed with a functionality.

8. The device as claimed in claim 6, wherein at least one contact member includes means for setting up a holding function between the contact member and a mating section.

9. The device as claimed in claim 1, further comprising at least one sensor for the sensory detection of the surroundings of the manipulator unit.

10. The device as claimed in claim 1, further comprising in addition to the lifting arrangement, driving means for the driven movement of the manipulator unit in the medium surrounding the manipulator unit.

11. The device as claimed in claim 1, further comprising radiation protection means which reduce or avoid penetration of radiation from the outside into an internal volume of the manipulator unit.

12. The device as claimed in claim 1, further comprising means for operating the device underwater and/or at comparatively high temperatures.

13. The device as claimed in claim 5, wherein the adjustment arrangement is present in the region of a center of gravity of the basic body of the manipulator unit.

14. The device as claimed in claim 1, wherein a main plane of the manipulator unit is tiltable by a tilting movement from a vertical orientation into a horizontal orientation.
